(19) United States
(12) Patent Application Publication
(10) Pub. No.: US 2016/0047518 A1
(43) Pub. Date: Feb. 18, 2016

(54) PROJECTION LIGHT MODULE FOR A MOTOR VEHICLE HEADLAMP HAVING A CENTRAL LENS MOUNT

(71) Applicant: Automotive Lighting Reutlingen GmbH, Reutlingen (DE)

(72) Inventor: Olaf Rottstaedt, Emsetal-Fischbach (DE)

(73) Assignee: AUTOMOTIVE LIGHTING REUTLINGEN GMBH, Reutlingen (DE)

(21) Appl. No.: 14/825,308

(22) Filed: Aug. 13, 2015

(30) Foreign Application Priority Data
Aug. 13, 2014 (DE) 10 2014 216 127.4

(51) Int. Cl. F21S 8/10

(52) U.S. Cl. CPC F21S 48/1216; F21S 48/1317; F21W 2101/10

(57) ABSTRACT

A projection light module for a motor vehicle headlamp having a lens mount that is divided into a first component and a second component, wherein a separating surface lying between the two components cuts the lens receiver, the mirrored shutter is clamped between the first component and the second component, wherein the position of the mirrored shutter in relation to the two components of the lens mount is determined by form fitting element that engage with one another, and the mirrored shutter has spacers facing toward the projection lens, which are in contact with the projection lens.

### CROSS-REFERENCE TO RELATED APPLICATIONS

The present application claims priority to and all the benefits of German Patent Application No. 10 2014 216 127.4, filed on Aug. 13, 2014, which is hereby expressly incorporated herein by reference in its entirety.

### BACKGROUND OF THE INVENTION

1. Field of the Invention

The present invention relates to a projection lens module for a motor vehicle headlamp having a central lens mount.

2. Description of the Related Art

A light module of this type is generally known in the related art and has a light source, a primary lens that bundles the light from the light source into an intermediate light distribution, a mirrored shutter delimiting the intermediate light distribution with a shutter edge, a projection lens that projects the delimited intermediate light distribution in a region in front of the light module, and a retaining structure that retains the light source with the primary lens, the mirrored shutter and the projection lens. The first retaining structure has a lens mount, which has an end at the light source side and an end at the projection lens side. The end at the projection lens side has a lens receiver, which is configured for accommodating the projection lens and retaining said lens by a form fit and/or force fit.

There are numerous types of projection lens modules for motor vehicle headlamps that are generally known in the related art. Classic poly-ellipsoid headlamp modules (PES modules), the name of which is derived from the shape of the reflectors used as the primary lens, normally have reflectors having light sources placed therein, as well as shutters and lens elements placed in the luminous flux of the light source. Modules with semiconductor light sources, in particular with light emitting diodes or laser diodes, which are in thermal contact with a heat sink that is attached thereto are also known. The shutters and lenses are also attached to this, normally massive, heat sink.

The projection lenses of the known light modules are attached to the lens mounts by springs, retaining rings, clamps, welding, injection molds etc. Provided that the known light modules have a heat sink and a lens mount, these do not contribute to the cooling.

With nearly all light modules, a mechanical color fringe adjustment is necessary. The undesired color fringe generated by a projection light module is the result of the different refractive powers of the projection lenses for different wavelengths. While the light beams of different wavelengths/colors refracted at different parts of the projection lens overlap in the bright region of the light distribution to form white light, a color fringe occurs at the light/dark border of the light distribution generated by the mirrored shutter. The intensity of the appearance of such a color fringe ultimately depends on component dimension tolerances and installation tolerances, which affect the spacing of the shutter edges from the projection lens and the shutter-side back focal length of the projection lens. The back focal length is to be understood to mean the distance from the outer surface vertex of the projection lens to the lens surface. The shutter edge is preferably disposed in the lens surface.

The spacing is adjusted during the installation of the light module for the mechanical color fringe adjustment, such that the color fringe appears to be as minimal as possible, i.e. having the lowest possible intensity. If no color fringe adjustment of this type is carried out, the color of the light at the light/dark border, depending on the magnitude of the tolerances, would constantly fluctuate on the street, which is distracting.

### SUMMARY OF THE INVENTION

The invention is distinguished from the related art in that the lens mount is divided into a first component and a second component, wherein a separating surface lying between the two components cuts the lens mount, such that the mirrored shutter is clamped between the first component and second component, wherein the position of the mirrored shutter in relation to the two components of the lens mount is determined by inter-engaging form-fitting elements, and in that the mirrored shutter has spacers facing toward the projection lens, which are in contact with the projection lens.

Because the lens mount is divided into a first component and a second component by a separating surface, said separating surface cutting through the lens receiver, this initially simplifies the installation of the projection light module. The projection lens can simply be placed in the lens receiver of the one component, wherein the mount is completed by adding the second component. A flattening or otherwise shaping of an edge of a lens receiver, which reduces the diameter of an undivided lens receiver after the insertion of the projection lens, as is necessary with undivided lens receivers in order to retain the inserted projection lens, is not necessary.

Because the position of the mirrored shutter in relation to the two components of the lens mount is determined by inter-engaging form-fitting elements, a very simple installation of the mirrored shutter is obtained, in conjunction with a very high precision for the position of the shutter edge in relation to the lens mount. The clamping attachment likewise contributes, in conjunction with the form-fitting positioning, to a very low installation effort. Because the mirrored shutter has spacers facing toward the projection lens, which are in contact with the projection lens, a very high precision for the determination of the spacing between the shutter edge and the light entry surface of the projection lens is obtained, in conjunction with a very low installation effort.

As a result, the intensity of a color fringe is then dominated by the component manufacturing tolerances. The installation tolerances are negligible in comparison. It is then no longer necessary to adjust the color fringe when the remaining imprecision of the specified spacing is no greater than ±0.2 mm, which can be obtained with a typical manufacturing precision of the parts.

The possible elimination of the color fringe adjustment for low beam light, without sacrificing quality, reduces the manufacturing effort and the manufacturing costs, which is a substantial development objective. The fact that, with standard lens edge geometries, an attachment of the lens without additional parts can occur, likewise contributes to lower costs. Furthermore, the invention makes it possible to eliminate a heat sink, or at least to use a smaller heat sink than that used in the prior art. On the whole, a simplified production is obtained, in conjunction with lower tolerances and a reduction in the structural space, weight and costs. The object of the invention can thus be seen as that of providing a projection light module having these advantages, and which can be, in particular, manufactured in a very inexpensive manner, having acceptable lighting properties.

One embodiment is distinguished in that the separating surface cuts through the end of the lens mount at the light source side and the end of the lens mount at the projection lens side.

The separating surface may also run where the projection lens has its greatest diameter, and thus runs such that the projection of the separating surface is a straight line on the main plane of the projection lens.

In another embodiment the separating surface may be a flat separating surface. With an intended use of the light module in a motor vehicle headlamp in a motor vehicle, on a level driving surface, the separating surface preferably lies parallel to the horizon.

Another embodiment is distinguished in that the first component has a first flange having form-fitting elements and second flange having form-fitting elements in its separating surface, wherein the form-fitting elements of the second flange are dimensioned and disposed as a mirror image of the form-fitting elements of the first flange.

The mirrored shutter may also have a shutter section with a shutter edge and two attachment sections, as well as two spacers, and is rigid, wherein the attachment sections have a shape adapted to the flanges, and are disposed on the mirrored shutter such that, in each case, an attachment section rests against one of the flanges, and wherein the attachment sections extend toward the lens receiver, over the flanges, and thus form spacers that are long enough that they are in contact with the projection lens placed in the lens receiver. The mirrored shutter has local matting in one design. In a further design the mirrored shutter is disposed horizontally, such that its shutter edge is projected by the projection lens as a light/dark border of a low beam light that conforms to regulations.

In one embodiment the spacers may be long enough that they are in contact with the projection lens with a slight tension.

Another embodiment is distinguished in that the second component has two flanges with form-fitting elements, which are dimensioned and disposed as a minor image of the flanges and form-fitting elements of the first component.

In yet another embodiment, the second component may have a base structure on its end lying opposite the end at the lens side, for attaching a printed circuit board having semiconductor light sources and primary lenses. The base structure may also be a part of the single-piece second component. The base structure may have a free end, which is preferably designed such that it can be fixedly connected to the light source side end of the first component by screws, rivets, swaging or a material bonding connection technology.

In one embodiment the second component is at least partially matte on its inner surface facing the mirrored shutter. The first component can also have an at least partially matte inner surface facing the shutter. In addition, the second component, and preferably also the first component, may each be composed of a material having good thermal conductivity, in particular a metal.

The lens mount may have second retaining structures, which are configured for retaining the light module in the headlamp. The second retaining structures may have spherical heads, with which the entire projection light module can be pivoted about an imaginary pivot axis running through both spherical heads.

In still another embodiment, the additional light sources may be disposed in the region beneath the level of the mirrored shutter. Such light sources can be used to supplement the low beam light distribution generated by the light sources disposed above the mirrored shutter, to form a high beam light distribution. It is to be understood that the features specified above, and to be explained below, can be used not only in the respective described combinations, but also in other combinations or in and of themselves, without abandoning the scope of the present invention.

### BRIEF DESCRIPTION OF THE DRAWINGS

Other advantages of the invention will be readily appreciated as the same becomes better understood by reference to the following detailed description when considered in connection with the accompanying drawings, wherein:

FIG. 1 shows an exemplary embodiment of a projection light module according to the invention, for a motor vehicle headlamp;

FIG. 2 shows the projection light module in an exploded view;

FIG. 3 shows one design of the first component of the lens mount, as a half-shell;

FIG. 4 shows the subject matter of FIG. 3, with supplementary attachment elements;

FIG. 5 shows the subject matter of FIG. 4 with a supplementary mirrored shutter adapted thereto;

FIG. 6 shows the subject matter of FIG. 5 together with a projection lens 16 inserted in the lens receiver of the first component 26.

### DETAILED DESCRIPTION OF THE INVENTION

Identical reference symbols indicate identical elements in the various figures thereby, or at least elements having comparable functions.

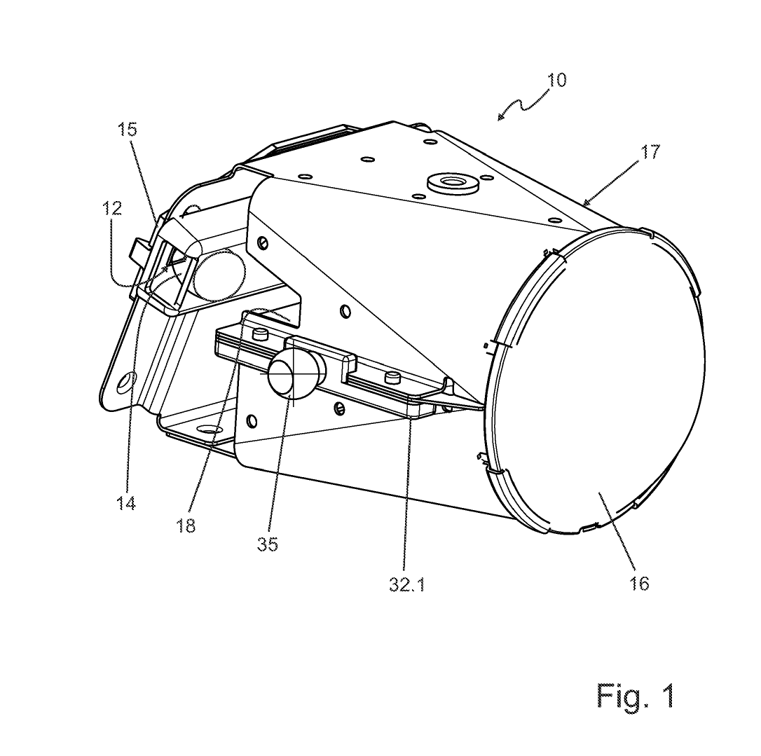

FIG. 1 shows one exemplary embodiment of a projection light module 10 according to the invention in detail, for a motor vehicle headlamp having a light source 12, a primary lens 14 and a projection lens 16. Furthermore, the projection light module 10 has a mirrored shutter 18, which can be seen more clearly in other figures. The projection light module 10 has a first retaining structure 17, which retains the light source 12, the primary lens 14, the mirrored shutter 18 and the projection lens 16.

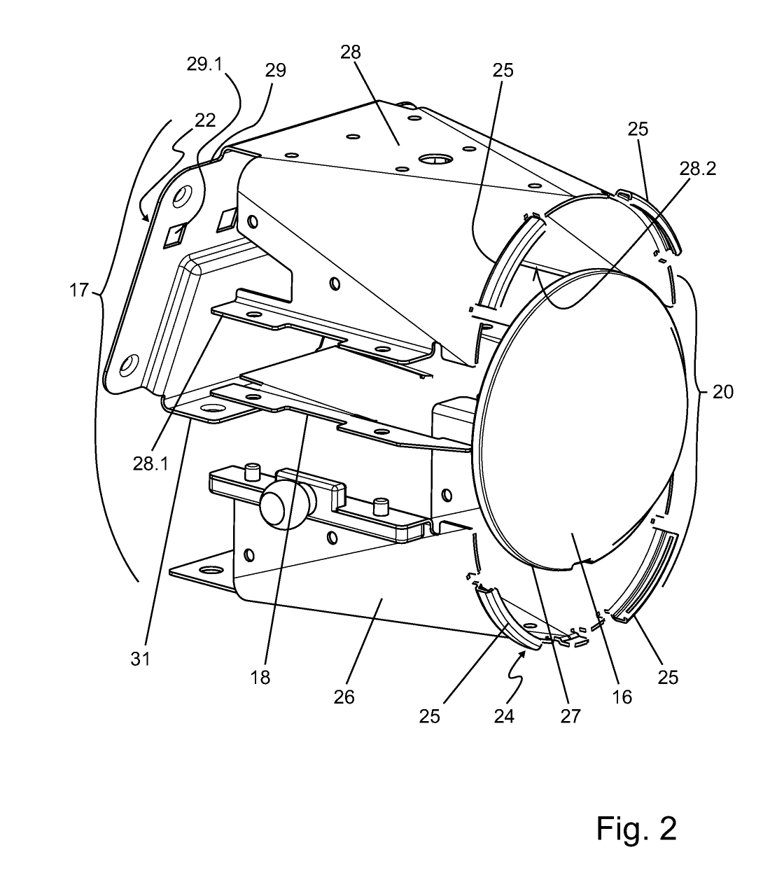

FIG. 2 shows the projection light module 10 from FIG. 1 in an exploded view. The first retaining structure 17, which retains the light source, the primary lens, the mirrored shutter 18 and the projection lens 16, has, in particular, a lens mount 20, having a light source side end 22 and a projection lens side end 24. The projection lens side end 24 has a lens receiver, which is configured for accommodating the projection lens 16 and to retain said lens by a form-fitting and/or force-locking connection.

The lens receiver has channel-shaped receiving elements 25, which are configured, by their dimensions and arrangement, to encompass projections 27 protruding from an edge of the projection lens 16 in the manner of a collar.

In another exemplary embodiment, the projection lens has recesses on its edge, which are configured, by their dimensions and arrangement, to receive projections, protruding from the edge of the lens receiver and pointed toward the interior of the projection lens, in a precise fit.

The lens mount 20 is divided, between its two ends, into a first component 26 and a second component 28. The division runs such that a separating surface lying between its two components 24 and 26 cuts the light source side end 22 and the projection lens side end 24. The separating surface preferably runs through the projection lens side end 24 there where the projection lens 16 has its greatest diameter, and the separating surface runs beyond this, such that its projection on the main plane of the projection lens 16 is a straight line. The important thing is that the separating surface cuts the lens receiver such that the projection lens 16 can be accommodated in the divided lens receiver without any plastic deformation of the components of the lens mount 20. The separating surface must thus intersect the projection lens side end 24 having the lens receiver. It is not, however, absolutely necessary that the separating surface also intersect the light source side end 22 of the lens mount 20. The separating surface can also have one or more angles, run in numerous planes, and/or have one or more steps functioning as form-fitting elements.

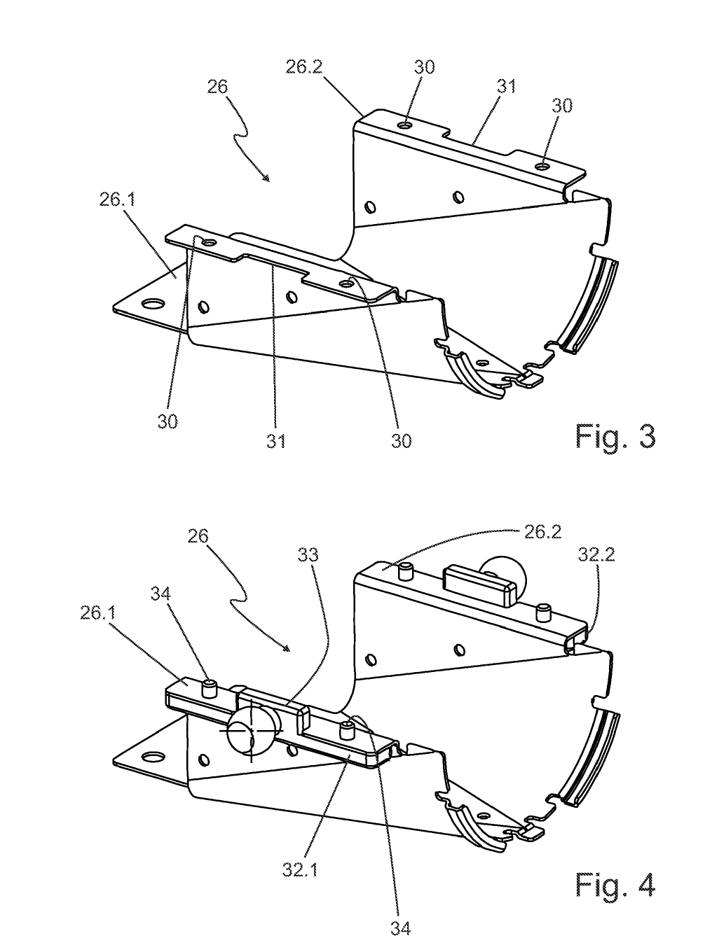

FIG. 3 shows one design for the first component 26 of the lens mount 20 as a half-shell. The separating surface is a flat separating surface in the depicted case. The half-shell has a first flange 26.1 and a second flange 26.2 in its separating surface. Each flange has n=2 form-fitting elements, which are realized as bores 30 in the depicted example. The number n of form-fitting elements can also be larger than two. The bores 30 are each located in the proximity of opposing flange ends of a flange, such that their spacing to one another along an imaginary line connecting the bores 30 is greater than their spacing to the next respective flange end of the flange lying in an extension of the connecting line. The flange has a recess 31 that is open toward the exterior in the flange plane, thus in the separating surface, which represents a further form-fitting element.

FIG. 4 shows the subject matter of FIG. 3, with supplementary attachment elements 32.1, 32.2. One side of the attachment element 32.1 is implemented as a counter flange to the flange 26.1 of the first component 26. The attachment element 32.1 has n form-fitting elements 32 on this side, which are precisely complementary to the n form-fitting elements 30 of the flange 26. In the present case, the form-fitting elements of the counter flange 32.1 are cylindrical alignment pins 34, which precisely fill the clear breadth of the bores 30. The position of the alignment pin is precisely defined in the separating surface, thus in the flange plane, and is only subjected to manufacturing tolerances, but not installation tolerances. The attachment element 32.1 has a material thickness in the direction perpendicular to the flange plane, which thickness is greater than the material thickness of the flange 26.1 of the half-shell, or the first component 26.1, respectively. The attachment element 32.1 thus forms a stable retainer for the half-shell shaped first component 26.1. The precision with which the attachment element 32.1 and the half-shell shaped first component are joined is increased in that the attachment element 32.1 has a projection 33, which protrudes from its flange plane in the same direction as the alignment pin, and is designed such that it fills the recess 31 in the flange of the half-shell shaped first component 26.1 that is open toward the outside. The projection 33 and the alignment pin 34 extend from the flange plane far enough that they also penetrate bores and recesses in a flange on the mirrored shutter 18 and a flange on the second component 28. The material thickness of the projection 33 is preferably greater than the material thickness of the attachment element outside the projection.

This applies analogously to a second flange connection, which lies opposite the first flange connection described so far, in the separating surface, and which, in particular, has the second attachment element 32.2. The second flange connection is preferably, but not necessarily, designed as a minor image of the first flange connection.

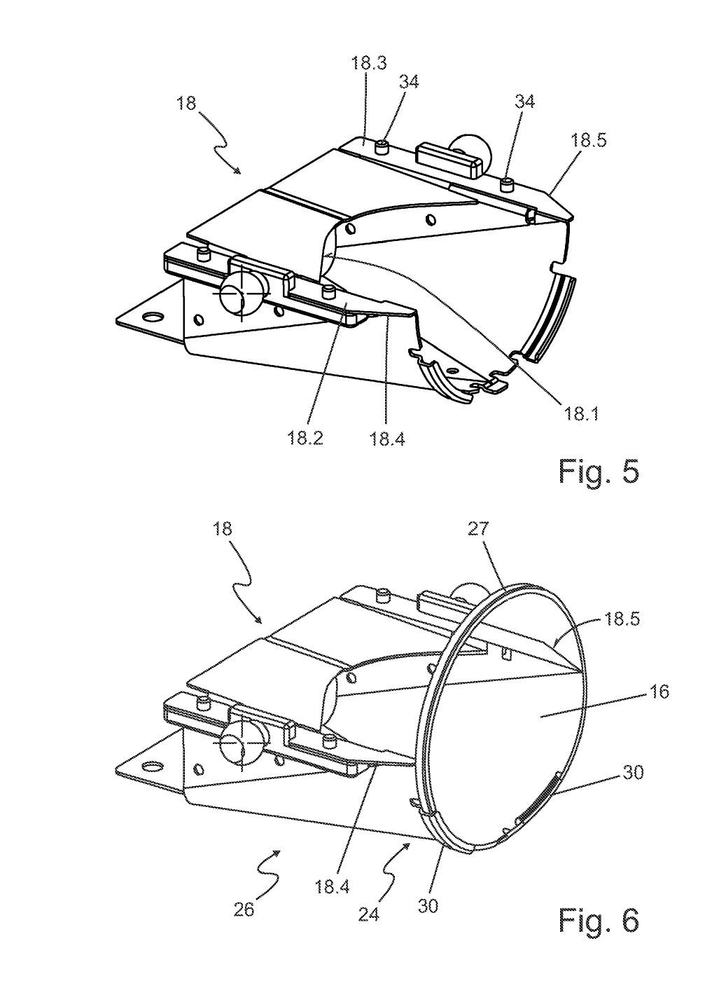

FIG. 5 shows the subject matter of FIG. 4 with a supplementary mirrored shutter 18 adapted thereto. The mirrored shutter 18 has a shutter section having a shutter edge 18.1 and two attachment sections 18.2, 18.3, as well as two spacers 18.4, 18.5, and is preferably rigid. The mirrored shutter is preferably a single-piece sheet metal part or plastic part. The attachment sections 18.2, 18.3 have a shape adapted to the flanges 26.1, 26.2, and are disposed on the mirrored shutter 18 such that one attachment section 18.2/18.3 rests against one of the flanges 26.1/26.2 in each case, and covers the respective flange. The attachment sections 18.2, 18.3 have bores thereby, which are disposed such that they cover the same area as the bores 30 in the flanges 26.1, 26.2, and are the same size thereof, and have the same shape. The open breadth of the bores is thus likewise precisely filled by the alignment pins 34.

By means of these features, the mirrored shutter 18 is positioned with a positioning imprecision, dominated by the manufacturing tolerances of the flanges, bores and alignment pins, on the first component 26.

The attachment sections 18.2, 18.3 protrude toward the lens receiver, beyond the flanges 26.1, 26.2. Those parts of the attachment sections 18.2, 18.3 that no longer server to attach the mirrored shutter 18 form spacers 18.4, 18.5, which improve the positioning precision of the projection lens 16 that will later be placed in the lens receiver.

FIG. 6 shows the subject matter of FIG. 5 together with a projection lens 16 placed in the lens receiver of the first component 26. The lens receiver disposed on the lens side end 24 of the first component 26 is composed of channel sections 30 formed in the lens side end 24. These are configured, by the shape and dimensions of their channel cross section, to receive, in an encompassing manner, a projection 27 protruding in the manner of a collar from the edge of the projection lens 16. As has been explained above, this can also be designed in the reverse manner, such that the projection lens 16 has recesses and the lens receiver has complementary projections that fit precisely thereto.

The spacers 18.4, 18.5 of the mirrored shutter 18 are long enough that they are in contact with the projection lens 16 placed in the lens receiver. The spacers are preferably long enough that they are in contact with the projection lens 16 with a slight tension. Potential play that may be present under certain circumstances, without such spacers, or potential positioning imprecision of the projection lens in the lens receiver without such spacers, is limited by the contact. As a result, the potentially still remaining imprecision, even in the case of direct contact, of the variables that influence the color fringe (spacing of the projection lens to the mirrored shutter, back focal length of the projection lens) is dominated by the manufacturing imprecisions, and is only a result of the installation to a subordinate extent.

Reference is again made to FIG. 2, described above, in the following, which also shows, in particular, the second component 28 of the lens mount 20.

The second component 28 has two flanges 28.1, 28.2 having form-fitting elements, which are dimensioned and arranged as minor images of the flanges 26.1, 26.2 and form-fitting elements of the first component 26. When the mirrored shutter 18 is joined to the first component 26, the attachment elements 32.1, 32.2 and the second half-shell shaped component 28, structural components are formed, that are stacked on top of one anther and connected by form-fitting elements that engage with one another.

In the design depicted therein, the second component 28 has a base structure 29 on its end 22 lying opposite the lens side end 24, for attaching a printed circuit board having semiconductor light sources and primary lenses. The base structure 29 is a part of the single-piece second component 28 here. The second component 28, and preferably also the first component, are preferably each made of a material having good thermal conductivity, in particular a metal. A part of this type can be inexpensively manufactured by shaping a stamped sheet metal part, thus contributing to keeping the manufacturing costs as low as possible.

The semiconductor light sources are preferably disposed on a printed circuit board, in thermal contact with the base structure. The base structure has a free end 31, which is preferably designed such that it can be fixedly connected to the light source side end of the first component by screws, rivets, swaging, or a material bonding connection technology. A very high rigidity and mechanical stability of the lens mount 20 serving as the central, first retaining structure 17 is obtained by this connection. It is to be understood that the base structure can also be a component of the first half-shell, or the first component 26 of the lens mount. In one design, the light source assembly, which has, in addition to the light sources, at least one printed circuit board, can be designed such that it is replaceable. When numerous light source assemblies are used, for a low beam light distribution and a supplementary high beam light distribution, for example, preferably at least one of the two assemblies is designed such that it can be replaced.

A further major advantage of the use of a good thermal conductor such as metal as the material for the lens mount 20 is that the lens mount 20 itself, with its two half-shells 26, 28, can be used as a heat sink, because it accumulates heat from the chips of the semiconductor light sources through the contact with the printed circuit board, distributes the heat well, and can discharge the heat into the surrounding air through its large surface area. The service life of semiconductor light sources is substantially determined by their prevailing temperature during operation. As a result of the manner of construction presented in this application, by use of half-shell shaped components of the lens mount, which are preferably made of sheet metal, the lens mount 20 can either directly accommodate the printed circuit board with the semiconductor light sources, or can simply be connected, in a thermally conductive manner, to a separate heat sink. The lens mount 20 thus forms a heat sink, and in any case, contributes to the cooling thereof. This is accompanied with the advantage that the light module 10 either does not require a separate heat sink, or if such a heat sink is necessary, then it can be smaller, lighter and thus less expensive than with the prior art.

Reference shall be made below to FIG. 1, which has already been described in part above. FIG. 1 shows, in particular, the subject matter of FIG. 2, together with light sources 12 and primary lenses 14 in an assembled state. The alignment pins of the attachment elements precisely fill, in particular, the open breadth of the bores in the second component 28 of the lens mount. Furthermore, the second component 28, analogously to the first component 26, has at least one form-fitting element, which interacts precisely with a complementary form-fitting element on the projection lens 16.

The spacers for the mirrored shutter 18 are dimensioned such that their length is sufficient for pushing the lens 18, with a slight tension, against the wall of the channel, such that the position of the projection lens, in the direction of its optical axis with respect to the shutter edge of the mirrored shutter 18, is determined by the spacing between the front edge of the spacer 18.4, 18.5 in contact with the projection lens and the bores 30 and the alignment pins 34, which spacing is only dominated by the manufacturing imprecisions and is substantially independent of installation imprecisions.

After joining the first component 26, the second component 28, the attachment elements 32.1, 32.2, the mirrored shutter 28, and the projection lens 19, in which the projection lens 16 and the mirrored shutter 18 are placed in a form-fitting manner between the half-shells, the respective components 28, 28 of the lens mount 20, the components are fixedly connected to one another. The fixed connection preferably occurs by riveting, swaging, in particular hot swaging, or screwing the two components 26, 28, or by a material bonding connection process, such as adhesion. The alignment pins can serve as attachment elements thereby, as rivets or as threaded studs, for example.

The light source 12 is preferably composed of an assembly of semiconductor light sources, which are attached, together with associated primary lenses 14 and a printed circuit board 15, to one of the two components. With the intended use of the light module, the light source 12 is located above the mirrored shutter. As already mentioned, one (or more) supplementary light source(s) can also be located beneath the mirrored shutter in an intended use thereof. FIG. 1 shows how the printed circuit board 15 and the primary lenses 14 are disposed on different sides of the material of the base structure 29, which also serves as a heat sink, thus protecting the primary lenses from an undesired load caused by discharging the heat of the chips in the semiconductor light sources. The semiconductor light sources are disposed in recesses 29.1 in the base structure. This is comparable to FIG. 2, which shows square-shaped recesses 29.1.

FIG. 1 thus also shows, in particular, the subject matter of FIG. 6, together with the second component 28 of the lens mount 20 and the printed circuit board, having semiconductor light sources and primary lenses. The primary lenses are preferably catadiotropic transparent solids, which collect the light emitted by the semiconductor light sources, bundle said light, and direct it toward the shutter edge of the mirrored shutter. The intermediate light distribution resulting therefrom at the shutter edge is projected by the projection lens into the region in front of the projection light module.

FIG. 1 also shows that the attachment elements have a spherical head, with which the entire projection light module can pivot about an imaginary pivot axis passing through the two spherical heads. Only one spherical head 32.1 is visible in FIG. 1, because the other is covered by the light module. The pivot axis runs parallel to a plane in the depicted example in which the shutter edge lies. This is therefore a pivot axis for adjusting or regulating a headlamp range.

The spherical heads represent a design for second retaining structures, which are configured for retaining the light module in the headlamp. The spherical heads are preferably attached to the projections 33 or are a material bonded component of the projections 3.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A projection light module for a motor vehicle headlamp, said light module having a light source, a primary lens that bundles the light of the light source into an intermediate light distribution, a mirrored shutter that delimits the intermediate light distribution with a shutter edge, a projection lens that projects the delimited intermediate light distribution in a region in front of the light source side end and projection lens side end, which projection lens side end has a lens receiver, which is configured for accommodating the projection lens and to retain it by means of a form fit and/or force fit, characterized in that wherein the lens mount is divided into a first component and a second component, wherein a separating surface lying between the two components cuts the lens receiver, in that the mirrored shutter is clamped between the first component and the second component, wherein the position of the mirrored shutter in relation to the two components of the lens mount is determined by form fitting elements that engage with one another, and in that the mirrored shutter has spacers facing toward the projection lens, which are in contact with the projection lens.

2. The projection light module as set forth in claim 1, wherein the separating surface cuts the light source side end and the projection lens side end.

3. The projection light module as set forth in claim 1, wherein the separating surface runs there where the projection lens has its greatest diameter, and runs such that the projection of the separating surface on the main plane of the projection lens is a straight line.

4. The projection light module as set forth in claim 1, wherein the separating surface is a flat separating surface.

5. The projection light as set forth in claim 1, wherein the first component has a first flange with form fitting elements and a second flange with form fitting elements in its separating surface, wherein the form fitting elements of the second flange are dimensioned and disposed as a mirror image of the form fitting elements of the first flange.

6. The projection light module as set forth in claim 5, wherein the mirrored shutter has a shutter section having a shutter edge and two attachment sections as well as two spacers, and is rigid, wherein the attachment sections have a shape adapted to the flanges and are disposed on the mirrored shutter such that, in each case, an attachment section rests against one of the flanges, and wherein the attachment sections extend toward the lens receiver, over the flanges, and thus form spacers that are long enough that they are in contact with the projection lens placed in the lens receiver.

7. The projection light module as set forth in claim 6, wherein the spacers are long enough that they are in contact with the projection lens with a slight tension.

8. The projection light module as set forth in claim 5, wherein the second component has two flanges with form fitting elements, which are dimensioned and disposed in a minor image to flanges and form fitting elements of the first component.

9. The projection light module as set forth in claim 1, wherein the second component has a base structure on its end lying opposite the lens side end, for attaching a printed circuit board having semiconductor light sources and primary lenses.

10. The projection light module as set forth in claim 9, wherein the base structure is a part of the single-piece second component.

11. The projection light module as set forth in claim 9, wherein the base structure has a free end, which is preferably designed such that it can be fixedly connected to the light source side end of the first component by screws, rivets, swaging, or a material bonding connecting technology.

12. The projection light module as set forth in claim 1, wherein the second component, and preferably the first component as well, are each formed from a material having good thermal conductivity, in particular a metal.

13. The projection light module as set forth in claim 1, wherein the sense mount has second retaining structures, which are configured to retain the light module in the headlamp.

14. The projection light module as set forth in claim 13, t wherein the second retaining structures have spherical heads, with which the entire projection light module can pivot about an imaginary pivot axis running through the two spherical heads.
